(19) United States
(12) Patent Application Publication
(10) Pub. No.: US 2012/0311696 A1
(43) Pub. Date: Dec. 6, 2012

(54) Override for Policy Enforcement System

(75) Inventors: Dima DATSENKO, Nesher (IL); Juda THITRON, Netaniy (IL); Eugene (John) NEYSTADT, Kfar-Saba (IL)

(73) Assignee: MICROSOFT CORPORATION, Redmond, WA (US)

(21) Appl. No.: 13/152,258

(22) Filed: Jun. 2, 2011

(51) Int. Cl. G06F 21/00

(52) U.S. Cl. 726/17

(57) ABSTRACT

A policy enforcement system may have a mechanism for assisting a user in obtaining an exception to a given policy. The mechanism may collect information from the user as to why the exception is requested, then manage the exception throughout a security system. An exception policy may define the conditions when a user may be granted an exception automatically, as well as when the exception may be granted only through an approval process. An exception created by the mechanism may be logged in an audit file so that each exception is documented. Different exceptions may be defined for different conditions and each exception may have one or more paths by which the exception may be granted. The policy enforcement system may be used for any type of access control to any resource, including URL resources, physical peripherals or networks, data or applications, or any other resource.

### BACKGROUND

Many policy enforcement systems observe various operations and grant or deny access to a resource based on a policy. The policy may be a set of conditions for granting access.

In a simple example, a network gateway may have a policy defined that grants access to a network when a user is authenticated and the device may meet certain criteria. The policy may define criteria such as having anti-virus components operational or current set of patches installed. When the user is not authenticated or when the device does not meet the policy criteria, the device may not be granted access to the network.

### SUMMARY

A policy enforcement system may have a mechanism for assisting a user in obtaining an exception to a given policy. The mechanism may collect information from the user as to why the exception is requested, then manage the exception throughout a security system. An exception policy may define the conditions when a user may be granted an exception automatically, as well as when the exception may be granted only through an approval process. An exception created by the mechanism may be logged in an audit file so that each exception is documented. Different exceptions may be defined for different conditions and each exception may have one or more paths by which the exception may be granted. The policy enforcement system may be used for any type of access control to any resource, including URL resources, physical peripherals or networks, data or applications, or any other resource.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram of an embodiment showing a system with an access control system and exception management system.

FIG. 2 is a flowchart of an embodiment showing a method for exception handling.

FIG. 3 is a flowchart of an embodiment showing an example method for a workflow for processing exceptions.

### DETAILED DESCRIPTION

A policy enforcement system may have a policy based mechanism for determining whether or not to grant access to a resource. When access is denied to a user, an exception mechanism may assist the user in obtaining an exception to the policy. In some cases, an exception policy may determine whether or not to automatically grant an exception or whether to deploy a workflow that gathers approval information from a manager or other person.

The exception mechanism may capture a reason or set of reasons why a user wishes to access the resource that is otherwise restricted. The request for access, along with the associated reasons, may be stored in an audit log. An auditor may read the audit log to assess whether the various access control systems are properly functioning and providing proper limitations on resource access. The audit log may also be used to generate a compliance report that lists exceptions granted, which may be a regulatory issue in some jurisdictions.

The exception mechanism may create an exception that may be used by the policy enforcement mechanism to override an existing policy that may prevent access to a resource. The exception may be for a specific period of time, for example 24 hours, or may be for a specific set of conditions, such as when the device being used to access the resource has a certain configuration.

The architecture of the policy enforcement system and exception mechanism may take several different forms. One form may be a client architecture where the access control decisions are performed on a device that is requesting access to a resource. In such an embodiment, a device, such as a personal computer may request access to a website or other resource. The access control system may operate on the personal computer to permit or deny access for a user to the resource.

In another form, the policy enforcement system may operate at a resource or at a gateway to a resource. For example, a network may have a gateway through which devices on the outside of the network may request access to the network. In such a case, the gateway device may have a policy enforcement system installed and operational. The exception mechanism may be executed on a second device and may be launched when the policy enforcement mechanism denies access.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

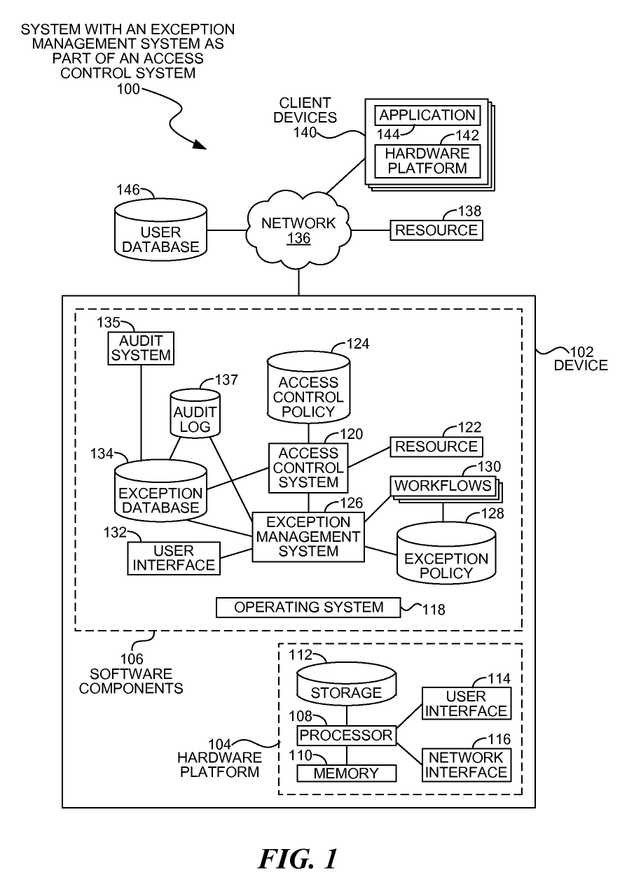

FIG. 1 is a diagram of an embodiment 100, showing a device 102 that may have an access control system and an exception management system. Embodiment 100 is an example of a device that may monitor access to a resource, then launch an exception management system that may or may not issue an exception to the access policy.

The diagram of FIG. 1 illustrates functional components of a system. In some cases, the component may be a hardware component, a software component, or a combination of hardware and software. Some of the components may be application level software, while other components may be operating system level components. In some cases, the connection of one component to another may be a close connection where two or more components are operating on a single hardware platform. In other cases, the connections may be made over network connections spanning long distances. Each embodiment may use different hardware, software, and interconnection architectures to achieve the described functions.

Embodiment 100 illustrates an access control system that has an exception management system. The access control system may restrict access to a resource based on an access control policy. The exception management system may provide a work around or exceptions to the access control policy for certain situations. In some cases, the exceptions may be automatically granted, while in other cases, the exceptions may be granted when approved by a manager or other person. All of the exceptions are logged in a log file for auditing.

An access control system may grant or deny access to a resource. A request may be received for the resource, and a policy may be applied to the request to determine whether or not to grant access. The policy may define conditions for which access may be granted or denied. In some cases, the conditions may be user-based conditions, such as whether a user is authenticated, the user's role or position in a company, or other characteristics. In some cases, the conditions may be device-based conditions, such as whether a device has a certain peripheral device, capability, application, anti-malware, or other settings or configurations. In some cases, the conditions may relate to time of day, day of week, or other factors. In some cases, the requests may relate to the type of data being requested.

The access control policy may be defined in a positive manner, such as defining the conditions for which access may be granted. Some access control policies may be defined in a negative manner, such as defining the conditions for which access will not be granted. In many embodiments, a single policy may define a large set of rules that define multiple conditions for which access may be granted or denied.

When a request is received, the access control system may analyze the various conditions to determine whether or not access may be granted. In some embodiments, the request may include all of the information that may be analyzed by the access control system. Such information may include all of the available parameters defined in the access control policy.

In other embodiments, the access control system may receive a request for access, then gather information defined in the access control policy. For example, the access control system may receive a request, determine which parameters are defined in the policy that relate to the request, and query the requesting device or a third party to gather the information to process the request. In such an embodiment, different user interfaces may be used to gather information in different circumstances. One user interface may be used for gathering information from a user with administrative or managerial credentials, while another user interface may be used to gather information from a user with a different set of credentials.

The resource may be any type of computing resource. For example, the resource may be a physical resource, such as access to a network, computer, storage system, or other physical resource. In some cases, the resource may be a peripheral device attached to a requesting device or some other device. The resource may be a data resource, such as a file, database, website, Uniform Resource Identifier (URI), or other source of data. The resource may be a computing resource, such as an application, process, service, or other computing resource.

The system of embodiment 100 is illustrated as being contained in a single device 102. The device 102 may have a hardware platform 104 and software components 106.

The device 102 may represent a server computer, dedicated gateway device, or other type of computing system that provides access control. In some embodiments, however, the device 102 may be any type of computing device, such as a personal computer, game console, cellular telephone, netbook computer, or other computing device.

The hardware components 104 may include a processor 108, random access memory 110, and nonvolatile storage 112. The processor 108 may be a single microprocessor, multi-core processor, or a group of processors. The random access memory 110 may store executable code as well as data that may be immediately accessible to the processor 108, while the nonvolatile storage 112 may store executable code and data in a persistent state.

The hardware components 104 may also include a network interface 114. The network interface 114 may include hardwired and wireless interfaces through which the device 102 may communicate with other devices.

The software components 106 may include an operating system 118 on which various applications may execute.

The device 102 may have an access control system 120 that may grant or deny access to a resource 122. Resource 122 may be located within the device 102 or within the control of the device 102. Examples of such a resource may include a data resource, such as a local database or file, an application executing on the device 102, or a peripheral device attached to device 102.

In other embodiments, the access control system 120 may provide access control to a remote resource 138. Some such embodiments may deploy the device 102 as a gateway or other device that receives requests from various devices and grants or denies access to the remote resource 138. In other embodiments, the access control system 120 may be located on a local device and may grant or deny access for the device 102 to the remote resource 138.

The access control system 120 may analyze a request for access to a resource by applying an access control policy 124 against the request. In some embodiments, the access control system 120 may receive a request that contains all of the information that may be analyzed. In other embodiments, a request may be received, then the access control system 120 may gather information so that the access control policy 124 may be analyzed. In such embodiments, the access control system 120 may query the requesting device, a third party, or other source of information so that the access control policy 124 may be analyzed.

When an access request is denied, an exception management system 126 may be launched. The exception management system 126 may attempt to create an exception to the access control policy 124. An exception may be a waiver, permission, or other mechanism through which a request may be granted, even though the conditions defined in an access control policy 125 may not be met.

The exception management system 126 may have an exception policy 128 that may define conditions under which an exception may be granted. In some cases, the exception policy 128 may define various workflows 130 that may be executed in order to grant an exception.

The workflows 130 may include processes or procedures that may define how an exception may be granted. In one example, a workflow 130 may define a user interface 132 that may collect reasons why a user may wish to access a resource. The reasons may be a business justification or other reason why access may be granted.

The reasons for access may be collected in several different manners. Some user interfaces may have a set of radio buttons, checkboxes, or other selection mechanisms through which a user may input information. Some user interfaces may have a text box or other input mechanism through which a user may enter a written explanation for why access may be granted.

In some embodiments, the user interface 132 may define certain criteria that, when met, will grant access to the user. In such embodiments, the user may self-certify or declare that the conditions are true and the exception policy 128 may automatically grant the exception.

In other embodiments, the user interface 132 may collect information that may be passed to a reviewer, who may be a manager or administrator of the resource, and the reviewer may grant or deny access to the resource based on the user's information.

The exception policy 128 may define different ways to handle different situations. For example, a marketing professional may wish to access a social network website that may be normally blocked within a corporation. Because the marketing professional may have a business need to access the social network website, the exception policy 128 may create an exception when the marketing professional self-certifies that the access is for a business need.

In the example, a similar request from a clerk in a warehouse for access to the same social network website may be transmitted to the clerk's manager and a human resources manager for approval prior to granting access. In some cases, the clerk's request may be denied without having a mechanism for obtaining an exception.

In the example, several different workflows may be followed based on information contained in the request. The example contained different workflows based on the user's position in the company.

In some embodiments, a workflow may allow a user to self-authenticate one or more parameters used by an exception policy. In other embodiments, certain parameters may be verified or authenticated by a third party. In some such embodiments, the authentication may come from a human reviewer that may approve or disapprove a request. In other embodiments, an automated system may authenticate certain information and pass such authenticated information to the exception management system 126 for consideration.

The exception management system 126 may generate exceptions that may be stored in an exception database 134. The exception database 134 may store exceptions and may be queried by the access control system 120 to determine if an exception already exists. If an exception already exists, a request matching the exception may be granted access to the requested resource.

The access control system 120 may examine the exception database 134 to determine if an exception exists when an access attempt occurs. When a valid exception exists, the access control system 120 may permit access. The exception management system 126 may generate an exception in the form of a token, Kerberos ticket, cookie, or some other identifier. In some cases, the exception may be validated by a third party, may be encrypted or digitally signed, or have some other authentication mechanism.

Once an exception is granted, a cryptographically strong token associated with the approved exception may be created. The token may be transferred to the client in the form of a cookie, Kerberos token, or other form. The client may then attached the token for each subsequent request as part of the authorization to access the resource.

In some embodiments, access to a resource while under an exception may cause different behaviors to occur. For example, a user who may access a restricted resource under an exception may have a higher level of monitoring applied to the access. The higher level of monitoring may flag auditors, managers, administrators, or other users of the access, or may have a greater degree of logging. In some cases, the resource may operate in a restricted mode that may have a reduced feature set or capabilities when a user accesses the resource using an exception compared to when another user may access the same resource without an exception. In some embodiments, such different behavior may be defined in an exception policy 128.

The exceptions may also be stored in an audit log 137. The audit log 137 may include requests for exceptions, which may include a user's reasoning for why an exception may be granted, along with the results of each exception request. The audit log 137 may be used in conjunction with an audit system 135 that may reconcile the exception requests with actual exceptions, as well as provide a mechanism for auditors to verify that the access control policy is being enforced. The documentation in the audit log may be reviewed by auditors to ensure that each exception is legitimate.

The device 102 may be connected to a network 136, which may be any form of a hardwired, wireless, or other network through which various devices may communicate. The network 136 may include local area networks, wide area networks, the Internet, cellular telephony networks, or any other type of network.

The resource 138 may be a remote resource for which access to the resource 138 may be controlled or monitored by the device 102. In some such embodiments, requests for access to the resource 138 may be processed by the device 102. When the device 102 has granted access to a the resource 138 through either the access control policy 124 or an exception, the device 102 may generate a token, cookie, Kerberos ticket, or other communication that may or may not be authenticated by the device 102. Such a token may be accepted by the resource 138 for access to the resource.

The device 102 may operate in conjunction with various client devices 140. The client devices 140 may operate on a hardware platform 142, which may be similar to the hardware platform 104. The client devices 140 may have various applications 144 that may request access to a resource, such as resource 122 on device 102 or a remote resource 138.

Some embodiments may have a user database 146 or other database that may contain information that may be used by an access control system 120 or exception management system 126. In such embodiments, the access control system 120 or exception management system 126 may query these external databases to determine information about users, devices, or other information that may be evaluated as part of an access control policy 124 or exception policy 128. Such external databases may be authenticated or at least considered more valid than self-authenticated information that comes directly from the requesting device. Such authentication procedures may be useful to combat spoofing or other hacking techniques for gaining unauthorized access to the resource.

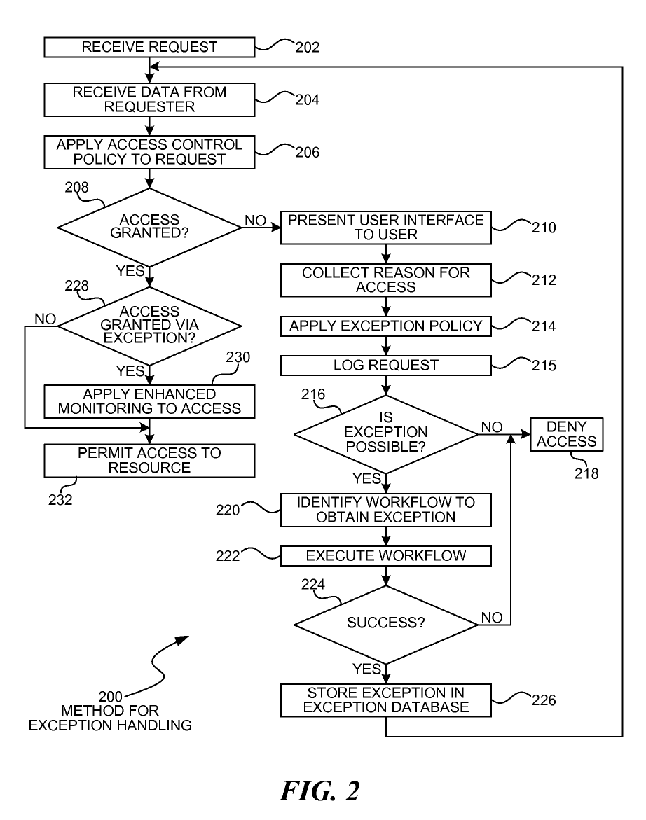

FIG. 2 is a flowchart illustration of an embodiment 200 showing a method for handling exceptions for an access control policy. Embodiment 200 is a simplified example of a method that may be performed by an exception management system, such as the exception management system 126 of embodiment 100.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 200 illustrates a simplified example of a method that may be used to handle exceptions from an access control system. Once access is denied, the exception handling process may begin.

In block 202, a request for access to a resource may be received. Data associated with the request may be received in block 204 and an access control policy may be applied to the request in block 206.

The request for access may include various information or parameters that may be defined for normal access. For example, a typical request may include an authentication token from the requesting device and may include authentication credentials for a user of the device in some cases. In some cases, additional information may be requested, such as device configuration information. Additional information may be requested by an access control system by sending a query to the device or another database.

After applying the access control policy in block 206, access to the resource may either be granted or denied in block 208.

If the access is denied in block 208, a user interface may be presented to a user in block 210 and a reason for access may be collected in block 212. In some embodiments, the user interface may be presented to a user based on a specific workflow that may be defined in an exception policy. The workflow may define certain parameters are evaluated as part of the workflow, and those parameters may populate a user interface through which the requesting user may request an exception. In such an embodiment, the user interface may change from one user to another, based on the user's device, credentials, role, time of day, access control system state, or other information.

In some embodiments, the user interface requesting an exception may be the same, no matter what the workflow may be. Such an embodiment may be useful when the system may not wish to make the user aware that an exception will not be granted. In such embodiments, the system may be designed to collect the user's reasons and store those reasons in a log file, no matter if the exception could possibly be granted.

After gathering information from the user regarding the exception request, an exception policy may be applied to the request in block 214 and the request may be logged in block 215. The exception policy may determine if the exception is possible or not. If the exception is not possible under any circumstances in block 216, the access may be denied in block 218.

The logging of block 215 may store the exception request along with any information captured from the user in block 212 into a log file. The log file may be used by an auditor, administrator, manager, or other authority to monitor the reasons why users wish to access a resource and the conditions surrounding such requests.

If the exception is possible in block 216, a workflow may be identified in block 220 and executed in block 222. An example of a typical workflow may be found in embodiment 300 presented later in this specification.

If the workflow executes and is not successful at generating an exception in block 224, the access may be denied in block 218.

If the workflow is successful at generating an exception in block 224, the exception may be stored in an exception database in block 226 and the process may return to block 204 to attempt to access the resource again.

If the access is granted in block 208 and the access has been granted via an exception in block 228, enhanced monitoring or other behavior modification may be applied in block 230 when access is granted in block 232. If the access is granted in block 208 in compliance with the access control policy, the access may be permitted in block 232 without additional monitoring or reduced functionality.

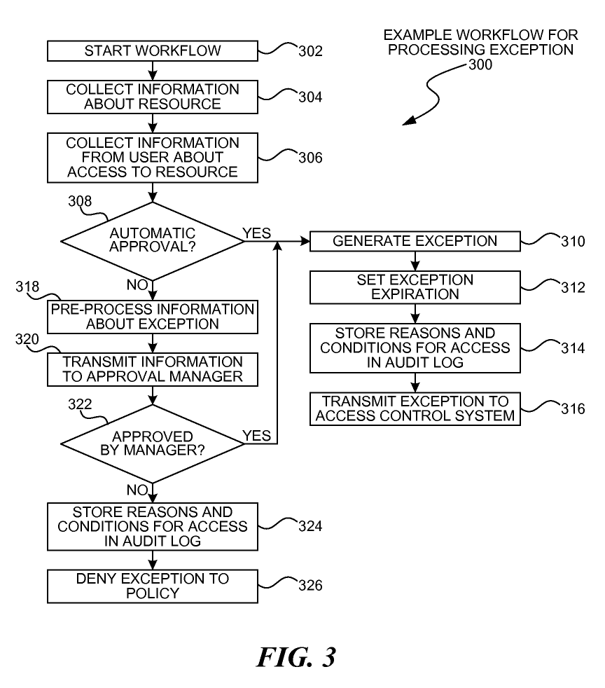

FIG. 3 is a flowchart illustration of an example embodiment 300 showing a workflow for processing an exception. Embodiment 300 is a simplified example of a method that may be performed as part of a workflow, such as the workflows 130 of embodiment 100.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 300 is an example workflow that may be implemented when access to a resource is not granted. Embodiment 300 is an example workflow that collects information and transmits the information about the exception request to a manager for approval.

In block 302, the workflow may begin.

Information may be collected about the resource in block 304. Information may also be collected in block 306 from the user about access to the resource. The information collected in block 304 may include a description of the resource, access limitations, costs, or other information that may be useful to a manager to approve or deny an exception. The information collected in block 306 may include business reasons for gaining access, intended uses of the resource, and any suggested limitations on the use. As an example of a limitation, the user may request access for a limited period of time, such as 24 hours, a week, or other time period.

The workflow or exception policy may evaluate the information collected in blocks 304 and 306 and determine if the approval can be automatically generated in block 308.

The exception may be automatically generated in block 308, the exception may be generated in block 310 along with an expiration time for the exception in block 312. The expiration time may be used by an access control system to acknowledge the exception for a limited period of time, after which the exception will be invalid and ignored.

The reasons and conditions for the exception may be stored in an audit log in block 314 for record keeping and audit purposes.

The exception may be transmitted to the access control system in block 316 so that a request fulfilling the conditions of the exception may be permitted access to the resource by an access control system.

If the automatic approval is not permitted in block 308, the request and any information received concerning the request may be pre-processed in block 318. The pre-processing may organize and present the information to an approval manager in block 320. The approval manager may view the information and make a decision to grant or deny the exception.

If the exception is approved in block 322, the process may proceed to block 310 to generate the exception.

If the exception is not approved in block 322, the reasons and conditions for the access request may be stored in the audit log in block 324 and the exception may be denied in block 326. When the exception is denied, the user may not be granted access to the resource.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A method performed on at least one computer processor, said method comprising:
detecting a first resource access attempt from a first user on a first device for a resource;
evaluating an access policy to determine that said user on said device is not permitted to access said resource;
presenting a first user interface to said user and collecting a reason for said user to access said resource;
evaluating said reason, said first user, and said device with an exception policy to determine that said first user may be granted an exception;
storing said reason in a log file and permitting said first user to access said resource;
detecting a second resource access attempt from a second user on a second device for said resource;
evaluating said access policy to determine that said second user on second said device is not permitted to access said resource;
presenting a second user interface to said second user and collecting a second reason for said second user to access said resource;
evaluating said second reason, said second user, and said second device with said exception policy to determine that said second user may not be granted an exception; and
storing said second reason in said log file and denying said second user to access said resource.

2. The method of claim 1 further comprising:
said access policy comprising a first level of monitoring for access to said resource;
said exception policy comprising a second level of monitoring, said second level being more detailed monitoring than said first level of monitoring, said second level of monitoring being applied to said first user when accessing said resource using said exception.

3. The method of claim 1 further comprising:
evaluating said exception policy to determine a first set of options available to said first user and presenting said first set of options to said first user in said first user interface;
evaluating said exception policy to determine a second set of options available to said second user and presenting said second set of options to said second user in said second user interface.

4. The method of claim 3, first user interface and said second user interface being different.

5. The method of claim 3, said first set of options and said second set of options each comprising at least one acceptable reason for granting an exception.

6. The method of claim 5 further comprising:
transmitting said reason to a third person for approval prior to granting said exception.

7. The method of claim 5 further comprising:
auditing said log file and presenting said first reason to a third user for approval after granting said exception.

8. The method of claim 1, said resource being a Uniform Resource Identifier being accessed through a web browser.

9. The method of claim 1, said resource being a data resource.

10. The method of claim 1, said resource being a network resource.

11. A system comprising:
a processor;
an access control system executing on said processor that:
monitors access to a resource;
detects requests from devices for said resource; and
applies policies to said requests to permit or deny access to said resource;
an exception management system that:
determines that a device has been denied access to said resource;
presents a user interface that collects a reason for access to said resource into a request for access;
processes said request for access using an exception policy, said exception policy defining conditions for granting an exception for said device to access said resource;
when said conditions defined in said exception policy are met, granting said exception; and
when said conditions defined in said exception policy are not met, denying said exception.

12. The system of claim 11, said access control system that further:
detects that said exception is present and permits access to said resource.

13. The system of claim 12, said exception policy comprising user based conditions and device based conditions.

14. The system of claim 13, said user based conditions comprising a user role.

15. The system of claim 14, said device based conditions comprising at least one device configuration parameter.

16. The system of claim 11 further comprising:
an audit system that:
stores said exception in an audit log, said exception comprising said reason for access.

17. The system of claim 11, said exception management system that further:
processes said request by transmitting said request to a person who reviews said request prior to granting said exception.

18. A method performed on a computer processor, said method comprising:
monitoring access to a resource by:
receiving an access request for said resource;
evaluating said access request against an access policy comprising a first set of conditions for access to said resource;
when said first set of conditions are met, permitting access to said resource;
when an exception to said access policy is valid, permitting access to said resource;
when said first set of conditions are not met, denying access to said resource and launching an exception management sequence;
said exception management sequence comprising:
presenting a user interface to a user, said user requesting access to said resource;
receiving a reason for said access from said user interface;
evaluating said reason against an exception policy comprising a second set of conditions for granting an exception;
when said second set of conditions are not met, denying said exception;
when said first set of conditions are met, granting said exception.

19. The method of claim 18, said exception management sequence further comprising:
transmitting said reason to a person; and
receiving approval from said person to grant said exception.

20. The method of claim 19 further comprising:
logging said approval and said reason.
